(19) United States
(12) Patent Application Publication
(10) Pub. No.: US 2016/0004797 A1
(43) Pub. Date: Jan. 7, 2016

(54) CIRCUIT DESIGNING SUPPORT APPARATUS AND PROGRAM

(71) Applicant: MITSUBISHI ELECTRIC CORPORATION, Tokyo (JP)

(72) Inventors: Susumu HIRANO, Tokyo (JP); Ryo YAMAMOTO, Tokyo (JP)

(73) Assignee: MITSUBISHI ELECTRIC CORPORATION, Tokyo (JP)

(21) Appl. No.: 14/755,977

(22) Filed: Jun. 30, 2015

(30) Foreign Application Priority Data
Jul. 1, 2014 (JP) 2014-135679

(51) Int. Cl. G06F 17/50

(52) U.S. Cl. CPC G06F 17/505; G06F 17/5072

(57) ABSTRACT

In circuit designing of a semiconductor integrated circuit or the like, reworks accompanying returning from the backend layout design are reduced, so that efficiency improvement (time reduction) of the entire development can be achieved. A high-level synthesis processing part conducts high-level synthesis of behavioral description. The synthesis result analyzing part acquires a layout designing condition being a condition concerning layout designing of a designing target circuit, and compares the layout designing condition with a high-level synthesis result. If any one element included in the high-level synthesis result is different from the layout designing condition, the synthesis result analyzing part decides a changing method of changing the hierarchical structure of the behavioral description. A hierarchy changing part changes the hierarchical structure of the behavioral description in accordance with the changing method decided by the synthesis result analyzing part.

### CROSS-REFERENCE TO RELATED APPLICATIONS

This application is based on and claims the benefit of priority from Japanese Patent Application No. 2014-135679, filed in Japan on Jul. 1, 2014, the content of which is incorporated herein by reference in its entirety.

### TECHNICAL FIELD

The present invention relates to a technique for supporting circuit designing of a semiconductor integrated circuit and the like.

### BACKGROUND ART

Due to a circuit scale increase accompanied by a recent micropatterning of LSIs, a very long designing period is needed to manually design an RTL (Register Transfer Level).

In connection with this, a high-level synthesis (also called behavioral synthesis) technique has been proposed in recent years which generates an RTL automatically from a behavioral description whose abstractness is higher than the RTL. A high-level synthesis tool that realizes the high-level synthesis technique is also commercially available.

According to a conventional designing method, a function designer examines the hierarchical structure (block division/integration and the like) in the behavioral description (for example, C++ language or SystemC language) (also in an RTL designing) and tends to decide the hierarchical structure for each function.

However, with a refinement of process and large scaling of LSIs which have been seen lately, this method often causes problems (wider layout area, wiring congestion, timing violation, and the like) in backend layout design, and reworks are often required in frontend design (behavioral description designing, RTL designing, and the like).

To cope with this, in the RTL designing, in many cases the hierarchical structure is determined considering the layout because of the above reason.

A hierarchical change during the RTL designing, however, requires a complicated and cumbersome task, which lowers designing efficiency.

Changing the hierarchical structure in the behavioral description is easier than that in the RTL designing. A proposal on changing the hierarchical structure in the behavioral description is also made (for example, see Patent Literature 1).

Regarding a timing violation as one of the problems in the layout designing, also proposed is a method of eliminating reworks by applying a synthesis constraint that is based on the actual layout result at a time of high-level synthesis (for example, see Patent Literature 2).

### CITATION LIST

### Patent Literature

[Patent Literature 1] International Publication WO 2011/155622

[Patent Literature 2] JP 2004-240530

### SUMMARY OF INVENTION

### Technical Problem

A conventional method disclosed in Patent Literature 1 describes changing the hierarchical structure in high-level synthesis. The object of this method is to evaluate the performance and decide a hierarchical structure that can provide the best performance. This method does not mention the problems in the layout designing.

A conventional method disclosed in Patent Literature 2 describes a method to shorten the time until a circuit is synthesized. The method is provided by a feedback means with which if a timing violation being one of the problems in the layout designing occurs, the actual layout result (wiring delay) is extracted and fed back to high-level synthesis. This method however does not mention other problems (wider layout area, wiring congestion, and the like) in the layout designing.

Further, according to this method, the layout result is fed back from the layout process being a later process in the entire LSI development. Therefore, it takes time to extract the design feedback.

The present invention is mainly aimed at solving the above problems, and has an objective to improve the efficiency (achieve time reduction) of the entire development in circuit designing of a semiconductor integrated circuit and the like, by decreasing reworks returning from the backend layout design.

### Solution to Problem

A circuit designing support apparatus according to the present invention includes:

a high-level synthesis processing part that conducts high-level synthesis of behavioral description which describes, using a hierarchical structure, a behavior of a designing target circuit;

a layout designing condition acquiring part that acquires a layout designing condition being a condition concerning layout designing of the designing target circuit;

a changing method deciding part that compares the layout designing condition with a high-level synthesis result obtained by the high-level synthesis processing part, and decides a changing method of changing the hierarchical structure of the behavioral description if any one element included in the high-level synthesis result is different from the layout designing condition; and

a hierarchy changing part that changes the hierarchical structure of the behavioral description in accordance with the changing method decided by the changing method deciding part.

### Advantageous Effects of Invention

According to the present invention, since the hierarchical structure can be designed considering the layout designing, reworks accompanying returning from the backend layout design are reduced, so that a high efficiency (time reduction) of the entire development is achieved.

### BRIEF DESCRIPTION OF DRAWINGS

The present invention will become fully understood from the detailed description given hereinafter in conjunction with the accompanying drawings, in which:

FIG. 1 is a diagram illustrating a configuration example of a semiconductor designing support apparatus according to Embodiment 1.

FIG. 2 illustrates an example of a behavioral description file according to Embodiment 1.

FIG. 3 illustrates an example of the behavioral description of ModuleA according to Embodiment 1.

FIG. 4 illustrates an example of the behavioral description of ModuleC according to Embodiment 1.

FIG. 5 is a flowchart indicating an operation example of the semiconductor designing support apparatus according to Embodiment 1.

FIG. 6 illustrates an example of a hierarchical structure according to Embodiment 1.

FIG. 7 illustrates a module synthesis result according to Embodiment 1.

FIG. 8 illustrates a configuration example of ModuleA according to Embodiment 1.

FIG. 9 illustrates a synthesis result of ModuleA according to Embodiment 1.

FIG. 10 illustrates an example of a changed behavioral description according to Embodiment 1.

FIG. 11 illustrates an example of a changed behavioral description according to Embodiment 1.

FIG. 12 illustrates an example of a changed behavioral description according to Embodiment 1.

FIG. 13 illustrates an example of a changed hierarchical structure according to Embodiment 1.

FIG. 14 illustrates a configuration example of ModuleC according to Embodiment 1.

FIG. 15 illustrates synthesis results of ModuleA and ModuleC according to Embodiment 1.

FIG. 16 illustrates synthesis results of Module_a, Module _ex, and Module_c according to Embodiment 1.

FIG. 17 illustrates the numbers of ports of changed modules according to Embodiment 1.

FIG. 18 illustrates an example of a changed hierarchical structure according to Embodiment 1.

FIG. 19 illustrates a configuration example of a semiconductor designing support apparatus according to Embodiment 2.

FIG. 20 is a flowchart indicating an operation example of the semiconductor designing support apparatus according to Embodiment 2.

FIG. 21 illustrates a hardware configuration example of the semiconductor designing support apparatus according to Embodiments 1 and 2.

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

### Embodiment 1

This and the following embodiments will describe a configuration provided with a data analyzing section that is based on a high-level synthesis result and a section that changes hierarchical levels of behavioral descriptions by high-level synthesis based on the analysis result of the data analyzing section. Thus, the behavioral description and RTL having a hierarchical structure can easily be designed considering the layout design. Reworks accompanying returning from the backend layout design are reduced, so that efficiency improvement (time reduction) of the entire development can be achieved.

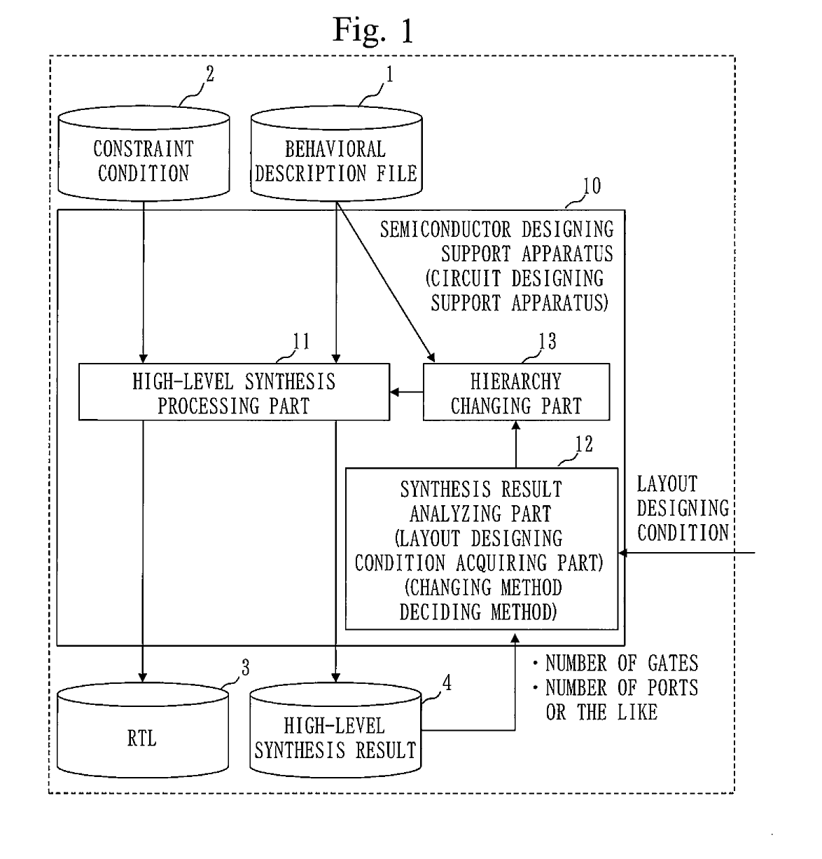

FIG. 1 is a configuration diagram illustrating a semiconductor designing support apparatus 10 according to Embodiment 1.

The semiconductor designing support apparatus 10 is an example of a circuit designing support apparatus.

Referring to FIG. 1, a behavioral description file 1 is a highly abstract computer program and is, for example, a file in which a behavior is described in an algorithm C language, C++ language, or SystemC language.

A constraint condition 2 is a constraint condition for executing a high-level synthesis and is inputted to the semiconductor designing support apparatus 10.

An RTL 3, being an output from the semiconductor designing support apparatus 10, is an RTL itself generated by a high-level synthesis processing part 11. A high-level synthesis result 4 is the result of high-level synthesis executed by the high-level synthesis processing part 11 and, more specifically, is a result report indicating the number of gates, the number of ports, timing information, and the like.

The high-level synthesis processing part 11 in the semiconductor designing support apparatus 10 serves to transform the behavioral description file 1 into a hardware special-use language RTL for the purpose of achieving an LSI and can also be replaced by a so-called marketed high-level synthesis tool.

A synthesis result analyzing part 12 receives the high-level synthesis result 4 and a layout designing condition and, based on these pieces of information, outputs guidelines and information on hierarchical change (block division/integration). A hierarchy changing part 13 actually conducts hierarchical change based on an output from the synthesis result analyzing part 12.

The layout designing condition is a condition concerning the layout designing of a semiconductor integrated circuit being a designing target.

The synthesis result analyzing part 12 acquires the high-level synthesis result 4 obtained by the high-level synthesis processing part 11 and the layout designing condition and compares the high-level synthesis result 4 and the layout designing condition.

If any one element included in the high-level synthesis result 4 is different from (does not match) the layout designing condition, the synthesis result analyzing part 12 decides a method of changing the hierarchical structure of the behavioral description corresponding to the element that does not match the layout designing condition.

The hierarchy changing part 13 changes the hierarchical structure of the behavioral description in accordance with the changing method decided by the synthesis result analyzing part 12.

The synthesis result analyzing part 12 is an example of a layout designing condition acquiring part and a changing method deciding part.

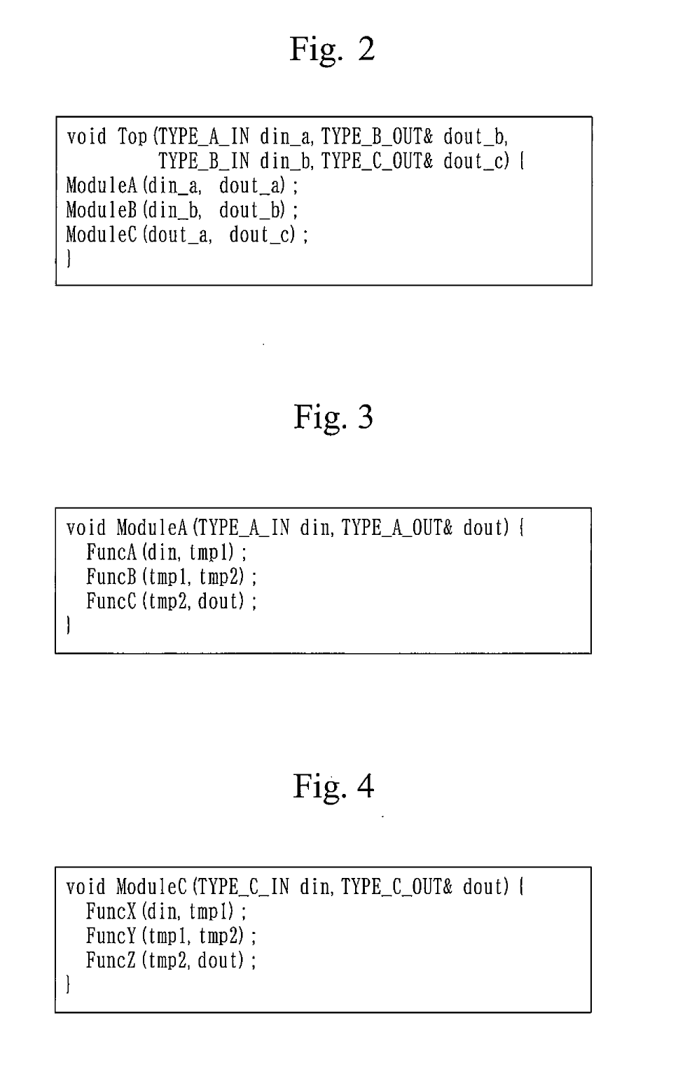

FIG. 2 illustrates an example of the behavioral description file 1 in FIG. 1 and indicates a behavioral description that includes three hierarchical levels (modules) of ModuleA, ModuleB, and ModuleC.

More specifically, it is understood from FIG. 2 that the hierarchical structure of the semiconductor integrated circuit as the designing target before the semiconductor designing support apparatus 10 operates is divided into three.

FIG. 3 illustrates the behavioral description of ModuleA, and FIG. 4 illustrates the behavioral description of ModuleC (ModuleB is not illustrated).

The descriptions indicated in FIGS. 2, 3, and 4 are excerpts for explaining a program described in the C++ language. The descriptions indicated in FIGS. 2, 3, and 4 are incomplete programs for being a behavioral description.

The present embodiment explains a behavioral description in the C++ language. However, the present embodiment is applicable to other languages.

The behavior will now be described.

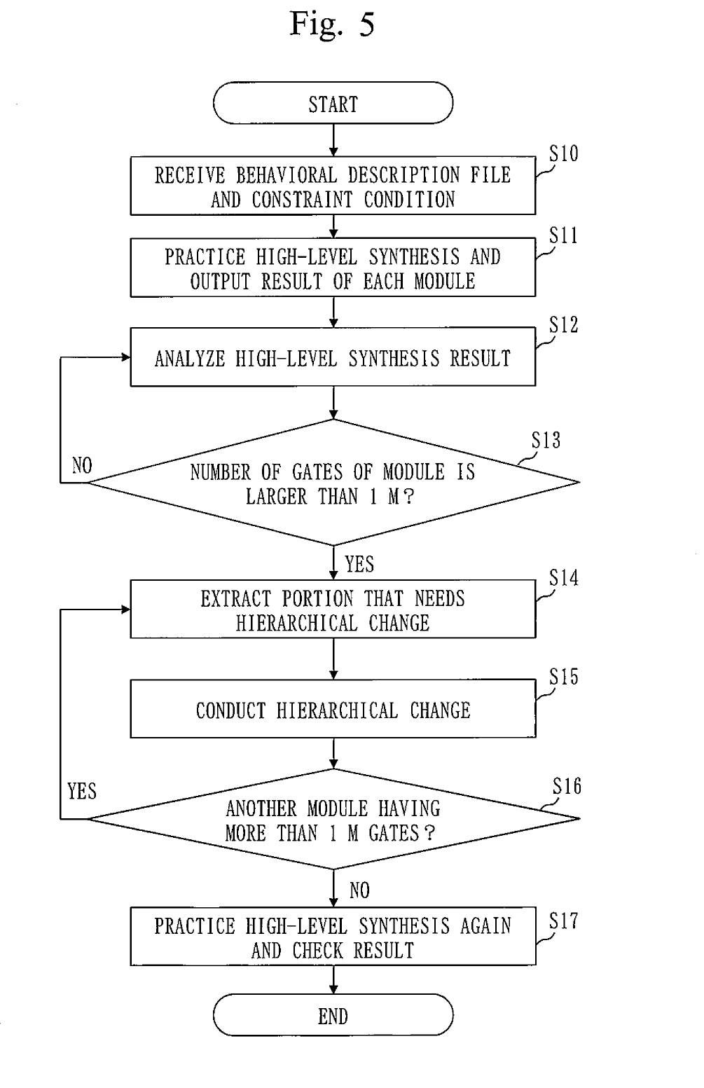

FIG. 5 is a flowchart indicating the operation of the semiconductor designing support apparatus 10. An explanation will be made by referring to FIG. 5.

First, the behavioral description file 1 whose hierarchical structure is needed to be optimized and the constraint condition 2 for high-level synthesis are inputted to the semiconductor designing support apparatus 10 (step S10).

C++ language codes illustrated in FIG. 2 is inputted as the behavioral description file 1.

A condition under which each function forms an RTL module will be given as the constraint condition 2.

The high-level synthesis processing part 11 transforms the behavioral description file 1 into RTL in accordance with the constraint condition 2, and outputs the RTL 3 and the high-level synthesis result 4 (step S11).

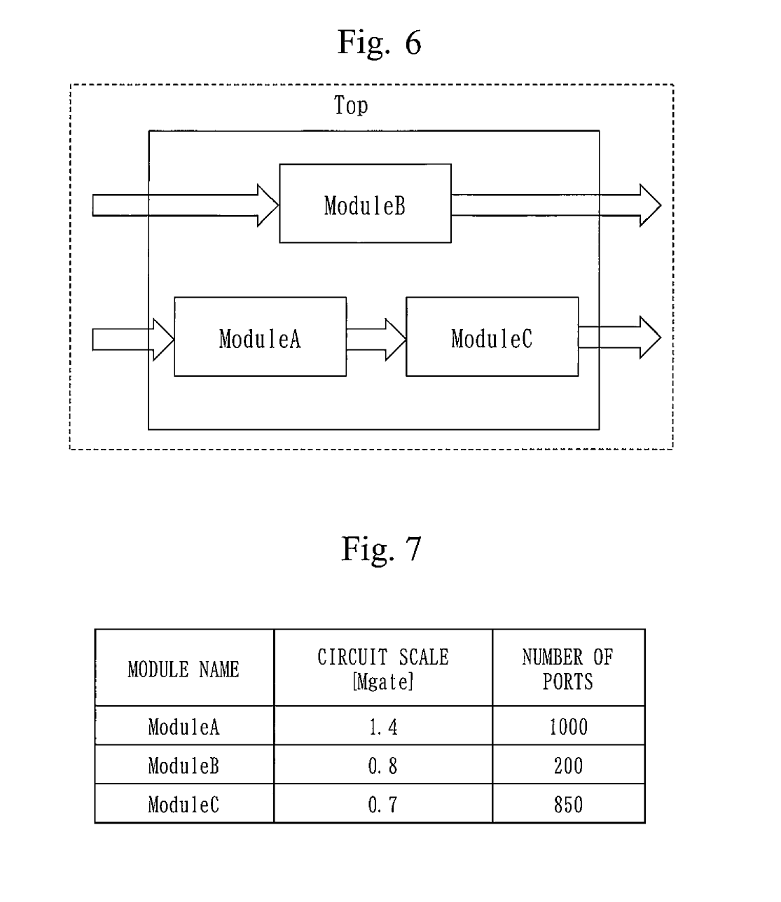

When the codes illustrated in FIG. 2 are inputted to the high-level synthesis processing part 11, an RTL having the hierarchy illustrated in FIG. 6 is generated.

Assume that a synthesis result illustrated in FIG. 7 will be obtained from the acquired synthesis result.

So far an ordinary high-level synthesis procedure has been described.

Then, the synthesis result analyzing part 12 performs analysis using the outputted information (the number of gates, the number of ports, and the like) of the high-level synthesis result 4, and the layout designing condition (step S12).

For example, in some recent cases, a layout constraint is imposed on the number of gates and the number of ports of a hierarchy (block) for each layout.

As an example, where there is a layout designing condition that the number of gates should be 1 M or less, if the number of gates in every module is less than 1 M, the hierarchy need not be changed. Then, the process returns to step S12, and the next hierarchical level is analyzed.

If there is a module having more than 1 M gates, the hierarchical level need be divided. Thus, the process advances to the hierarchical change of step S14.

In step S14, the synthesis result analyzing part 12 extracts a portion that needs hierarchical change.

For extraction, the synthesis result of a low-level hierarchy module in the target module is analyzed.

Since this embodiment takes the circuit scale as the criterion, the synthesis result analyzing part 12 extracts a module having the largest circuit scale.

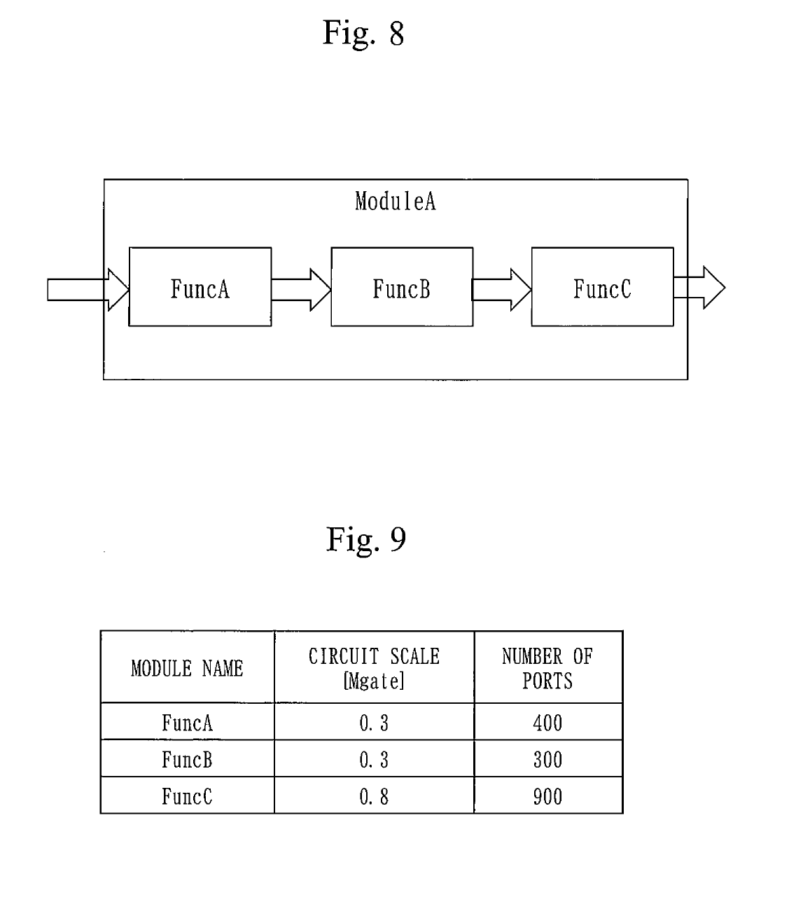

FIG. 8 illustrates the module configuration of the inner modules of ModuleA, and FIG. 9 illustrates a synthesis result of the inner modules.

In this example, FuncC is extracted as it has the largest circuit scale.

As a method of changing the hierarchical structure, the synthesis result analyzing part 12 decides on a method of extracting FuncC from the parent function ModuleA while leaving the other functions FuncA and FuncB to remain in the parent function ModuleA.

Then, in step S15, the hierarchy changing part 13 conducts hierarchical change in accordance with the changing method decided by the synthesis result analyzing part 12.

In the hierarchical change, the extracted function is separated from the parent function (parent hierarchical level), and a new function (hierarchical level) is generated.

In this example, FuncC is extracted from the parent function ModuleA, and the other functions FuncA and FuncB are left to remain in the parent function ModuleA.

More specifically, the hierarchy changing part 13 changes the codes of the behavioral description file 1 as follows.

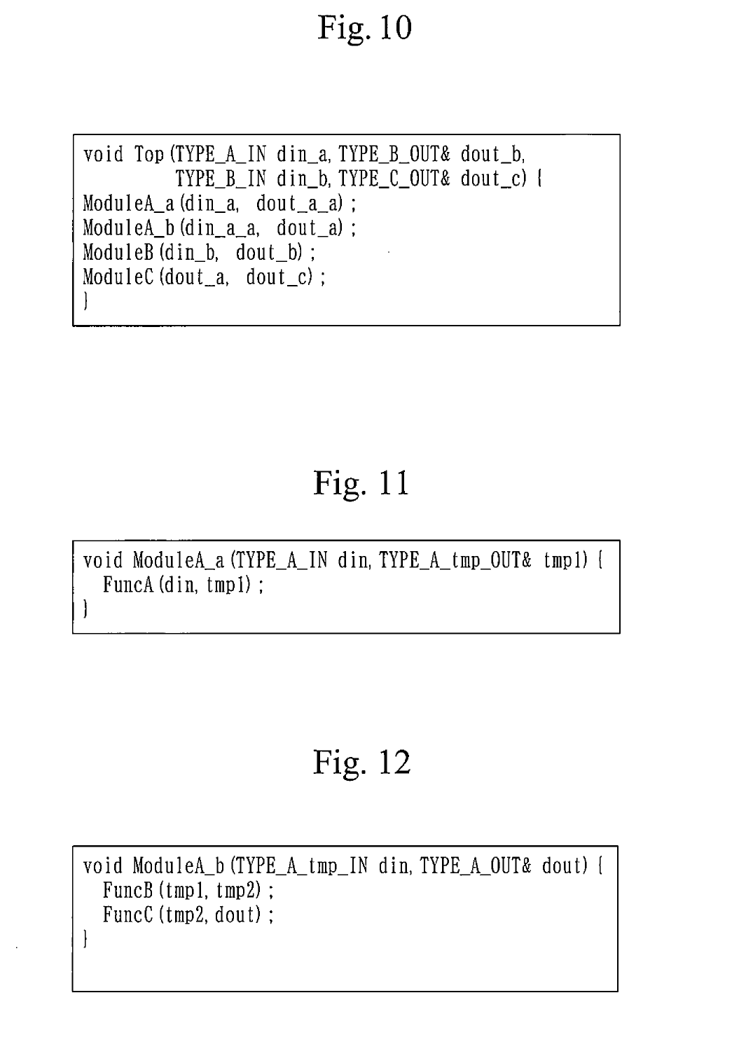

The extracted function FuncC is separated in terms of codes from ModuleA which is the parent function of the extracted function FuncC, and a new function ModuleA_a is generated (FIG. 11). A function ModuleA_b is generated by putting together the other remaining functions (FIG. 12). Furthermore, ModuleA (FIG. 10) is regenerated that connects the new function FuncA_a and the function ModuleA_b.

Namely, the code of ModuleA (FIG. 3) is divided into ModuleA_a (FIG. 11) and ModuleA_b (FIG. 12), and the Top hierarchical level (FIG. 2) is replaced by the structure illustrated in FIG. 10.

Then, in step S16, it is checked whether or not there exists another hierarchical level (module) that has more than 1 M gates. If exists, the process returns to step S14, and steps S14 to S16 are repeated.

If not in step S16, the process advances to step S17. The high-level synthesis of the hierarchy-changed behavioral description is performed. It is then checked whether or not this changed hierarchical level has 1 M gates or less.

Steps S14 to S16 are repeated until the changed hierarchical level has 1 M gates or less.

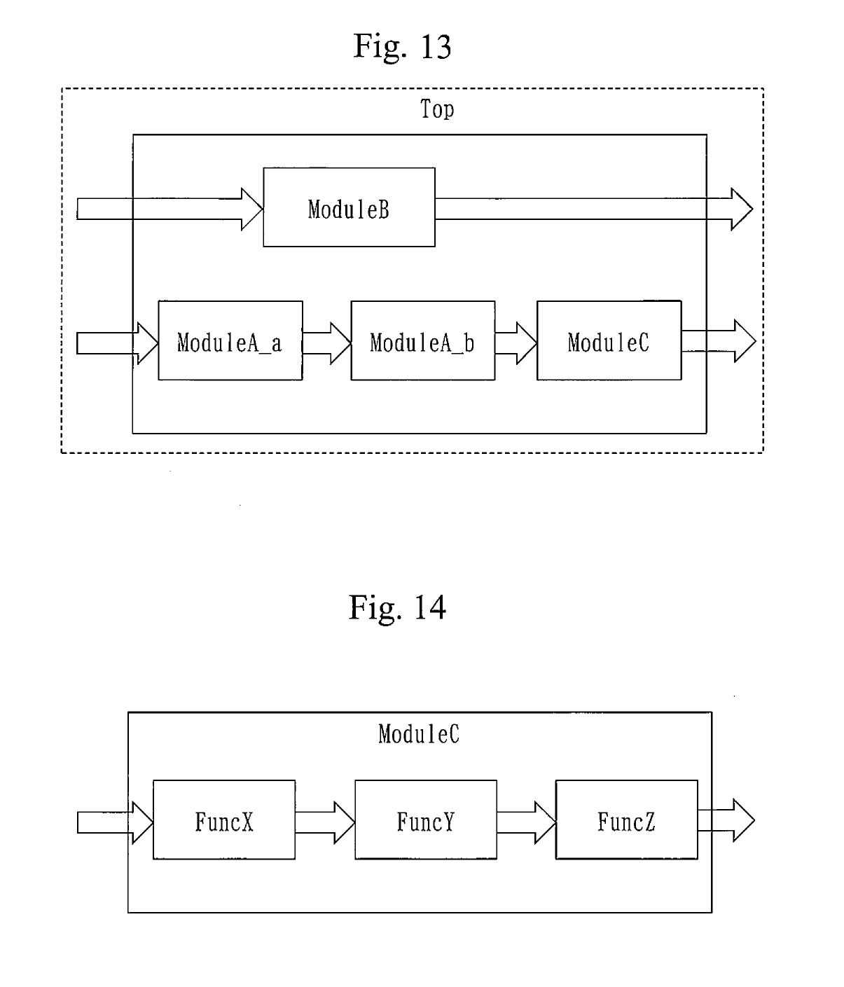

The resultant RTL hierarchy thus obtained is illustrated in FIG. 13.

In this example, the functions (hierarchical levels) are separated. It is also possible to integrate functions (hierarchical levels).

For example, all gates of each of divisible units such as lower-level hierarchical levels or functions of ModuleA may be outputted in advance in high-level synthesis, and the functions (hierarchical levels) may be combined such that the resultant number of gates is 1 M or less.

In this embodiment, the codes are divided. Alternatively, the hierarchical change may be performed by changing only the constraint condition instead of changing the codes.

In the above example, the circuit scale is used as the criterion. Alternatively, the number of ports may be used as the criterion.

A case will be described which requires 900 ports or less as a layout designing condition.

First, in step S11, the number of ports is obtained as part of the high-level synthesis result.

Then, in step S13, the synthesis result analyzing part 12 specifies a hierarchical level that exceeds the layout designing condition, being the decision criterion, on the number of ports.

In the example of this embodiment, the number of ports is 1000 in ModuleA, which exceeds the criterion of 900. Thus, concerning ModuleA, the process advances to step S14.

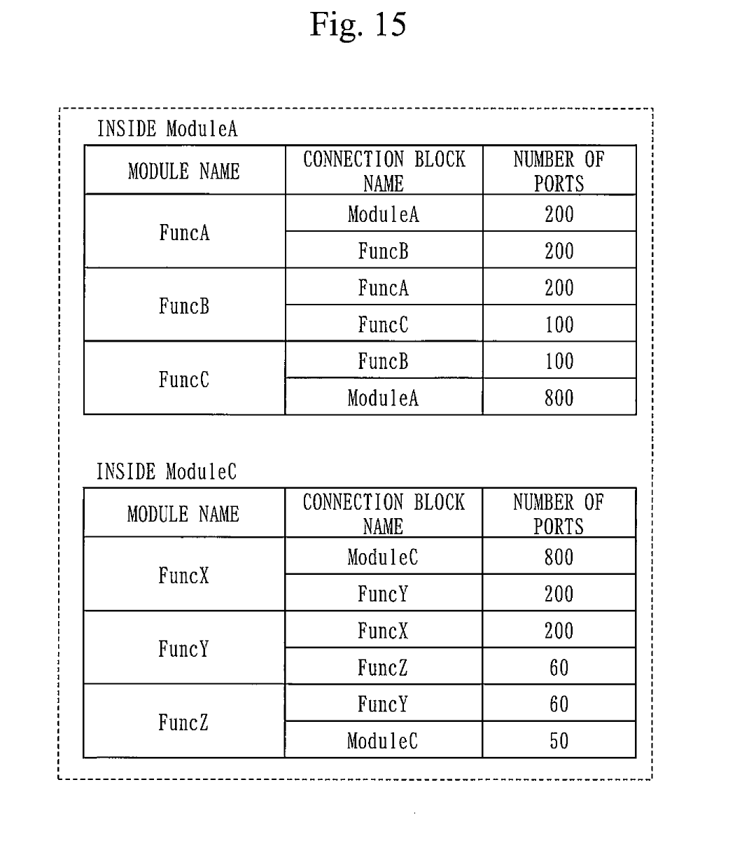

In step S14, the synthesis result analyzing part 12 extracts from the synthesis result (FIG. 15) of the lower-level hierarchical level (FIG. 14), a function whose number of ports to be connected to ModuleA is the maximum.

In this example, FuncC having 900 ports is extracted (100 ports for connection with FuncB+800 ports for connection with ModuleA=900 ports).

Furthermore, the synthesis result analyzing part 12 looks up the synthesis result of ModuleC to which FuncC is connected via ModuleA.

In ModuleC, since FuncC is connected to FuncX, the synthesis result analyzing part 12 decides to conduct hierarchical change for FuncC and FuncX.

More specifically, the synthesis result analyzing part 12 decides as follows. First, a function Module_cx is generated by integrating FuncX and FuncC. Then, a function Module_a is generated by removing FuncC from the parent function ModuleA. Also, a function Module_c is generated by removing FuncX from the parent function ModuleC.

The hierarchy changing part 13 conducts hierarchical change in the above procedure in accordance with the changing method decided by the synthesis result analyzing part 12.

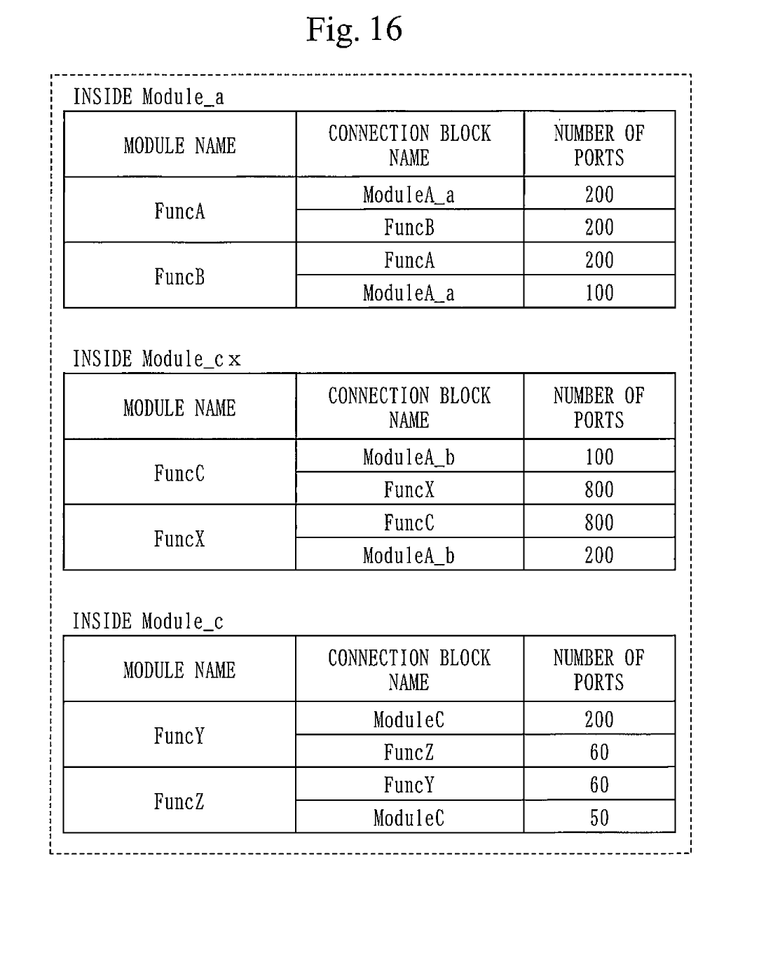

FIG. 16 illustrates the resultant number of ports of each Func obtained by the above process.

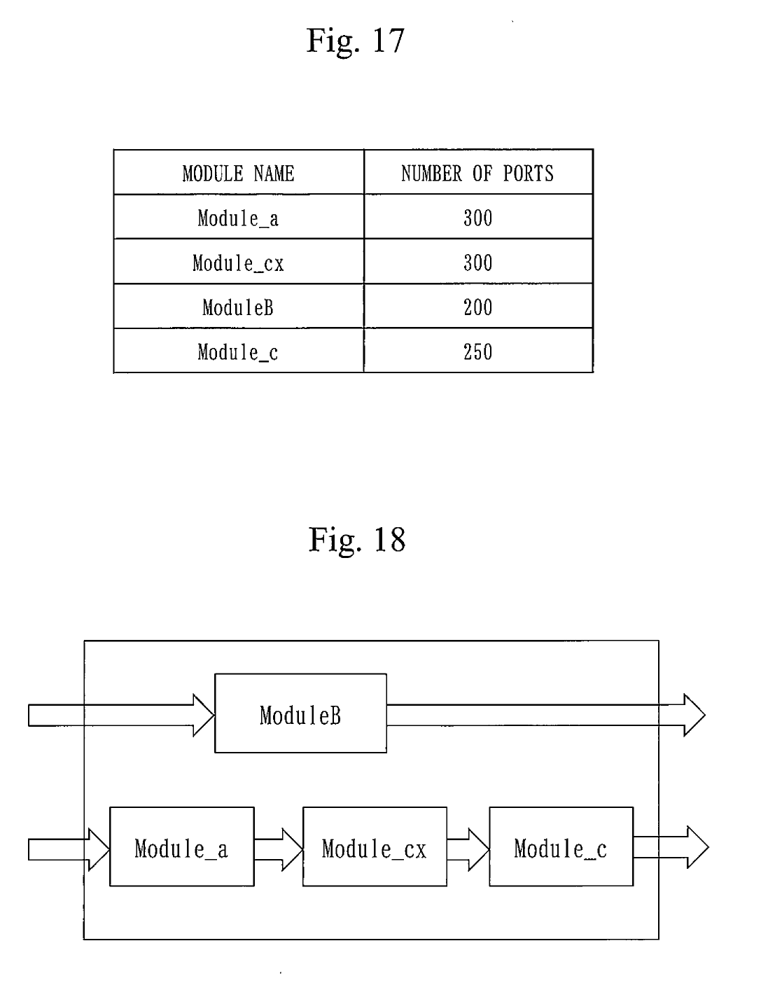

FIG. 17 illustrates the numbers of ports of Top Module.

Based on the result of Top, if the number of ports is equal to or less than the criterion, the process is ended.

If the number of ports does not satisfy the criterion, function integration is repeated until the criterion is satisfied.

After this hierarchical change, high-level synthesis is conducted again, and final check is carried out.

FIG. 18 illustrates an RTL hierarchical structure of an obtained synthesis result.

In the above example, the criterion is about each of the circuit scale and the number of ports. However, the two criteria may be combined to form an evaluation function (for example, the number of pin pairs obtained by dividing the number of ports by the number of gates), and the evaluation function may be used as the decision criterion.

In the above embodiment, the hierarchy is divided based on functions. Alternatively, the code may be divided at arbitrary portions, and high-level synthesis may be performed again. This process may be repeated to decide dividing positions that match the condition such as the circuit scale.

As described above, the semiconductor designing support apparatus 10 is provided with a data analyzing section that is based on a high-level synthesis result and a section that changes hierarchical levels of behavioral descriptions by high-level synthesis based on the analysis result of the data analyzing section. Thus, the behavioral description and RTL having a hierarchical structure can easily be designed considering the layout design. Reworks accompanying returning from the backend layout design are reduced, so that efficiency improvement (time reduction) of the entire development can be achieved.

Hierarchy division can be conducted considering the layout design, which contributes to the reduction of the area and power consumption.

### Embodiment 2

In Embodiment 1, the hierarchical levels are changed using directly the high-level synthesis information of each hierarchical level. In Embodiment 2, the timing violation information of the entire design block is focused, and only a hierarchical level where a timing violation occurs is divided.

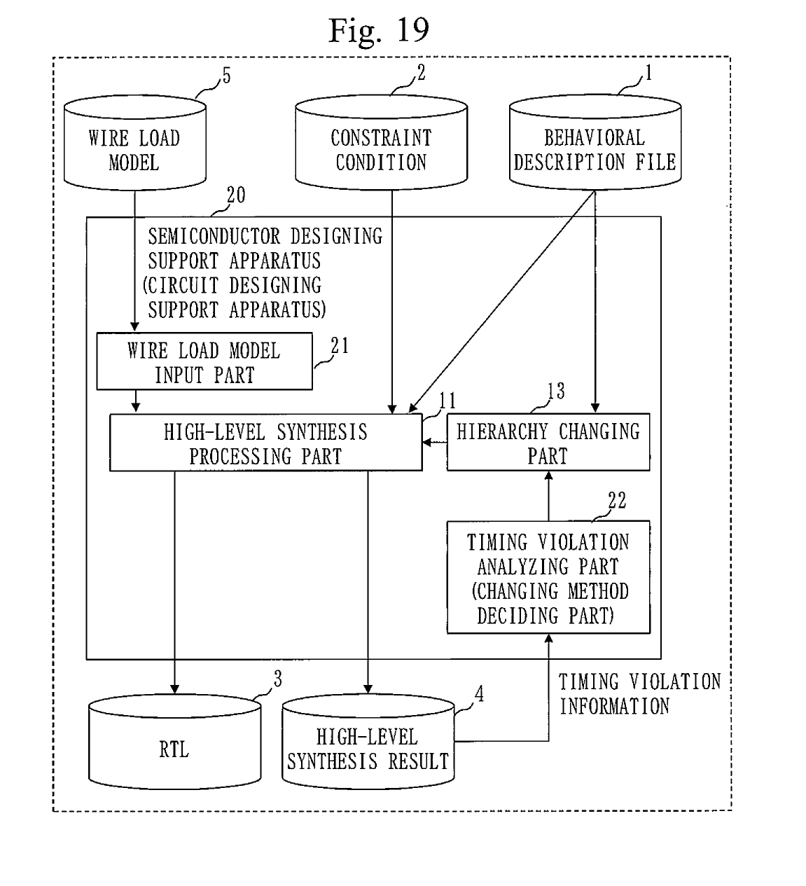

FIG. 19 is a configuration diagram illustrating a semiconductor designing support apparatus 20 of such a case according to Embodiment 2.

The semiconductor designing support apparatus 20 is an example of a circuit designing support apparatus.

Referring to FIG. 19, the components of Embodiment 2 are the same as those of Embodiment 1 except for the semiconductor designing support apparatus 20, a wire load model 5, a wire load model input part 21, and a timing violation analyzing part 22, and accordingly those identical components will not be explained repeatedly.

The semiconductor designing support apparatus 20 is the same as in Embodiment 1 except that a wire load model input part 21 can receive the wire load model 5 and that the timing violation analyzing part 22 is provided which analyzes timing violation information of a high-level synthesis result 4.

The wire load model 5 is used frequently for logical synthesis of an RTL and specifies the capacitance and delay depending on the number of gates and the number of fan-outs of a target circuit. Generally, the wire load model 5 exists for each semiconductor process.

The wire load model input part 21 transforms information of the wire load model 5 into information for high-level synthesis.

The timing violation analyzing part 22 receives timing violation information of the high-level synthesis result 4, analyzes the timing violation, extracts an element where the timing violation occurs, and decides a method of changing the hierarchical structure of the behavioral description corresponding to the extracted element.

The timing violation analyzing part 22 is an example of a changing method deciding part.

The operation will now be described.

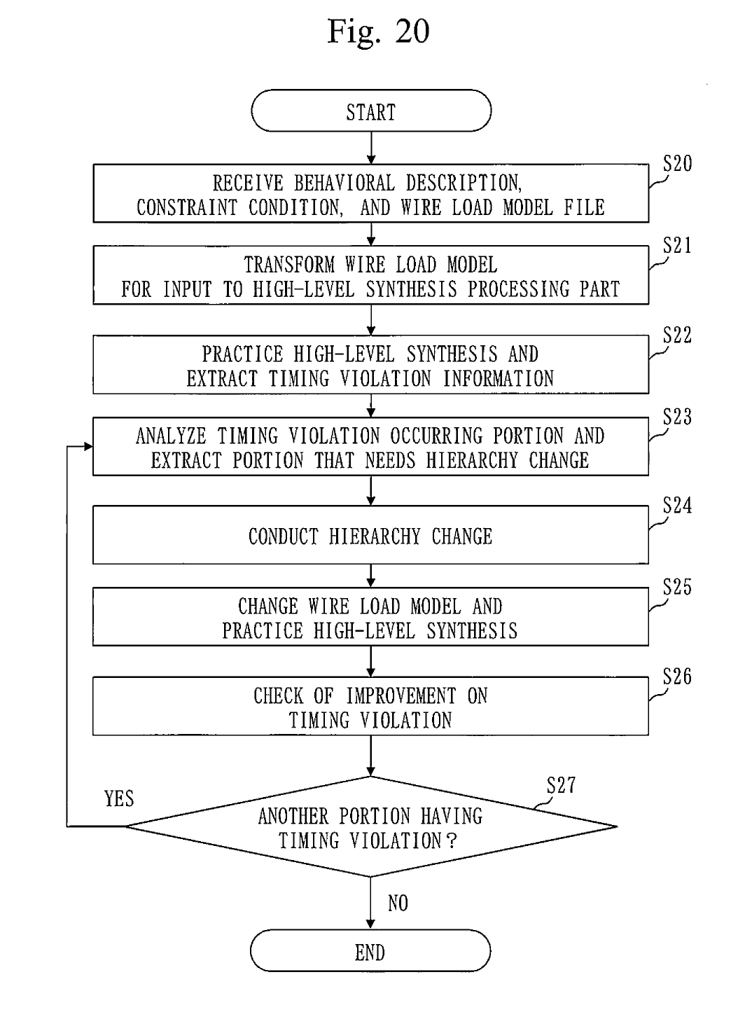

FIG. 20 is a flowchart indicating the operation of the semiconductor designing support apparatus 20. An explanation will be made by referring to FIG. 20.

First, the behavioral description file 1 whose hierarchical structure is needed to be optimized, a constraint condition 2 for high-level synthesis, and the wire load model 5 are inputted to the semiconductor designing support apparatus 20 (step S20).

The wire load model input part 21 transforms the information of the wire load model 5 into the information that can be received by a high-level synthesis processing part 11 as a constraint for the high-level synthesis (step S21).

More specifically, information on the capacity and delay of the wire load model 5 is replaced by delay information the high-level synthesis processing part 11 can read.

For example, in the high-level synthesis processing part 11, the delay value of a cell such as a flip-flop or NAND gate is regulated to 0.3 ns. Information on the wire load model 5 is reflected to this delay value. In a block having a few number of gates, the wiring is shorter and the delay is smaller. Thus, the delay of 0.3 ns is replaced by 0.1 ns.

For replacing the delay value, how to transform the information on the capacity and delay of the wire load model 5 into the delay information need be decided in advance in a trial-and-error manner.

The high-level synthesis processing part 11 transforms a behavioral description file 1 into RTL in accordance with the wire load model input part 21 and the constraint condition 2, and outputs an RTL 3 and the high-level synthesis result 4. Then, timing violation information is extracted from the high-level synthesis result 4 (step S22).

The timing violation information is inputted to the timing violation analyzing part 22. The timing violation analyzing part 22 analyzes the timing violation information to detect a portion where the timing violation occurs (step S23).

More specifically, the timing violation analyzing part 22 detects the hierarchical level (a module, function, or the like) that includes a portion where the timing violation occurs, extracts the lowest-level hierarchical level in that portion, and decides the method of changing the hierarchical structure corresponding to the extracted hierarchical level.

Then, only the detected hierarchical level is divided by a hierarchy changing part 13 (step S24).

The actual method of changing the hierarchical level by the hierarchy changing part 13 is the same as that in Embodiment 1, and accordingly a repetitive explanation will be omitted.

For the portion subjected to the hierarchical change, the high-level synthesis processing part 11 practices high-level synthesis again such that the value of the wire load model corresponding to the circuit scale of that portion is applied to that portion (step S25). It is checked if improvement on the timing violation is attained (step S26).

Then it is checked whether or not there exists another portion having this timing violation (step S27). If there exists another portion in step S27, the process returns to step S23, and steps S23 to S27 are repeated.

If not in step S27, the process is completed.

If timing violation is not eliminated by this operation yet, another countermeasure (such as circuit modification) may be needed in addition to the method explained in this embodiment.

In the above description, the hierarchical structure is divided into smallest hierarchical levels including a timing violating portion. If there are too many smallest hierarchical levels, the layout task would become complicated and cumbersome. Therefore, the hierarchical structure may be divided in a higher hierarchical level as long as a timing violating does not occur.

In that case, hierarchical change and high-level synthesis are repeatedly performed so that the hierarchical level of as high as possible a level where no timing violating occurs can be extracted.

As described above, the semiconductor designing support apparatus 20 is provided with a data analyzing section that is based on the timing violation result of high-level synthesis and a section that divides a hierarchical level of behavioral description where timing violation occurs, by high-level synthesis based on the analysis result of the data analyzing section. Thus, a delay in a portion where the timing is difficult to control can be improved without requiring the manual operation by the designer.

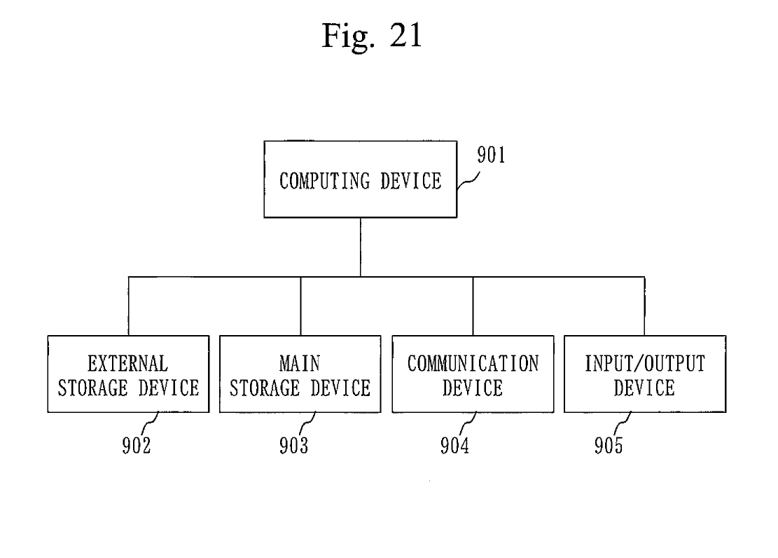

Finally, a hardware configuration example of the semiconductor designing support apparatuses 10 and 20 respectively indicated in Embodiments 1 and 2 will be described by referring to FIG. 21.

The semiconductor designing support apparatuses 10 and 20 are computers. The elements of the semiconductor designing support apparatuses 10 and 20 can be implemented by programs.

As the hardware configuration of each of the semiconductor designing support apparatuses 10 and 20, a computing device 901, an external storage device 902, a main storage device 903, a communication device 904, and an input/output device 905 are connected to a bus.

The computing device 901 is a CPU (Central Processing Unit) which executes the programs.

The external storage device 902 is, for example, a ROM (Read Only Memory), a flash memory, or a hard disk device.

The main storage device 903 is a RAM (Random Access Memory).

The communication device 904 is, for example, an NIC (Network Interface Card).

The input/output device 905 is, for example, a mouse, a keyboard, or a display device.

The programs are usually stored in the external storage device 902. The programs as loaded in the main storage device 903 are sequentially read and executed by the computing device 901.

The programs implement functions each explained as “part” in FIG. 1.

Furthermore, the external storage device 902 also stores an operating system (OS). The OS is loaded in the main storage device 903 at least partly. The computing device 901, while executing the OS, executes the programs each of which implements the function of “part” in FIG. 1.

The information, data, signal values, and variable values representing the results of the processes described in the explanations of Embodiments 1 and 2 as “to judge”, “to determine”, “to extract”, “to analyze”, “to decide”, “to change”, “to set”, “to set”, “to acquire”, “to select”, “to generate”, and the like are stored, in the form of files, in the main storage device 903.

The configuration of FIG. 21 merely presents an example of the hardware configuration of the semiconductor designing support apparatuses 10 and 20. The hardware configuration of the semiconductor designing support apparatuses 10 and 20 is not limited to that illustrated in FIG. 21, but can be another configuration.

Numerous additional modifications and variations are possible in light of the above teachings. It is therefore to be understood that, within the scope of the appended claims, the disclosure of this patent specification may be practiced otherwise than as specifically described herein.

### REFERENCE SIGNS LIST

1: behavioral description file; 2: constraint condition; 3: RTL; 4: high-level synthesis result; 5: wire load model; 10: semiconductor designing support apparatus; 11: high-level synthesis processing part; 12: synthesis result analyzing part; 13: hierarchy changing part; 20: semiconductor designing support apparatus; 21: wire load model input part; 22: timing violation analyzing part

1. A circuit designing support apparatus comprising:
a high-level synthesis processing circuit that conducts high-level synthesis of behavioral description which describes, using a hierarchical structure, a behavior of a designing target circuit;
a layout designing condition acquiring circuit that acquires a layout designing condition being a condition concerning layout designing of the designing target circuit;
a changing method deciding circuit that compares the layout designing condition with a high-level synthesis result obtained by the high-level synthesis processing circuit, and decides a changing method of changing the hierarchical structure of the behavioral description if any one element included in the high-level synthesis result is different from the layout designing condition; and
a hierarchy changing circuit that changes the hierarchical structure of the behavioral description in accordance with the changing method decided by the changing method deciding circuit.

2. The circuit designing support apparatus according to claim 1, wherein the changing method deciding circuit extracts an element that is different from the layout designing condition, and decides the changing method of changing of the hierarchical structure of the behavioral description corresponding to the element extracted.

3. The circuit designing support apparatus according to claim 1,
wherein the high-level synthesis processing circuit conducts high-level synthesis of the behavioral description whose hierarchical structure has been changed by the hierarchy changing circuit,
wherein the changing method deciding circuit compares the layout designing condition with the high-level synthesis result obtained by the high-level synthesis processing circuit, and decides the changing method of changing the hierarchical structure of the behavioral description again if any one element included in the high-level synthesis result is different from the layout designing condition; and
wherein the hierarchy changing circuit changes the hierarchical structure of the behavioral description again in accordance with the changing method decided by the changing method deciding circuit.

4. The circuit designing support apparatus according to claim 1, wherein the layout designing condition acquiring circuit acquires at least either one of a condition for the number of gates and a condition for the number of ports, as the layout designing condition.

5. A circuit designing support apparatus comprising:
a high-level synthesis processing circuit that conducts high-level synthesis of behavioral description which describes, using a hierarchical structure, a behavior of a designing target circuit;
a changing method deciding circuit that decides a changing method of changing the hierarchical structure of the behavioral description if timing violation occurs in any one element included in a high-level synthesis result obtained by the high-level synthesis processing circuit; and
a hierarchy changing circuit that changes the hierarchical structure of the behavioral description in accordance with the changing method decided by the changing method deciding circuit.

6. The circuit designing support apparatus according to claim 5, wherein the changing method deciding circuit extracts an element in which the timing violation occurs, and decides the changing method of changing of the hierarchical structure of the behavioral description corresponding to the element extracted.

7. The circuit designing support apparatus according to claim 5,
wherein the high-level synthesis processing circuit conducts high-level synthesis of the behavioral description whose hierarchical structure has been changed by the hierarchy changing circuit,
wherein the changing method deciding circuit decides the changing method of changing the hierarchical structure of the behavioral description again if timing violation occurs in any one element included in a high-level synthesis result obtained by the high-level synthesis processing circuit; and
wherein the hierarchy changing circuit changes the hierarchical structure of the behavioral description again in accordance with the changing method decided by the changing method deciding circuit.

8. A program that causes a computer which conducts circuit designing support, to execute:
a high-level synthesis process of conducting high-level synthesis of behavioral description which describes, using a hierarchical structure, a behavior of a designing target circuit;
a layout designing condition acquiring process of acquiring a layout designing condition being a condition concerning layout design of the designing target circuit;
a changing method deciding process of comparing the layout designing condition with a high-level synthesis result obtained by the high-level synthesis process, and deciding a changing method of changing the hierarchical structure of the behavioral description if any one element included in the high-level synthesis result is different from the layout designing condition; and
a hierarchy changing process of changing the hierarchical structure of the behavioral description in accordance with the changing method decided by the changing method deciding process.

9. A program that causes a computer which conducts circuit designing support, to execute:
a high-level synthesis process of conducting high-level synthesis of behavioral description which describes, using a hierarchical structure, a behavior of a designing target circuit;
a changing method deciding process of deciding a changing method of changing the hierarchical structure of the behavioral description if timing violation occurs in any one element included in a high-level synthesis result obtained by the high-level synthesis process; and
a hierarchy changing process of changing the hierarchical structure of the behavioral description in accordance with the changing method decided by the changing method deciding process.
